(19) United States
(12) Patent Application Publication
(10) Pub. No.: US 2010/0327124 A1
(43) Pub. Date: Dec. 30, 2010

(54) METHOD AND DEVICE FOR LATERALLY TRIMMING AN AIRPLANE DURING A FLIGHT

(75) Inventor: Vincent Lebas, Toulouse (FR)

Correspondence Address: J. Rodman Steele;Novak Druce & Quigg LLP, 525 Okeechobee Blvd, Suite 1500, West Palm Beach, FL, 33401, US

(73) Assignee: AIRBUS (SAS), Blagnac (FR)

(21) Appl. No.: 12/818,834

(22) Filed: Jun. 18, 2010

(30) Foreign Application Priority Data
Jun. 24, 2009 (FR) 0903059

(51) Int. Cl. B64C 13/16; G05D 1/00

(52) U.S. Cl. 244/76 R; 701/3

(57) ABSTRACT

A method and device for laterally trimming an airplane during a flight is disclosed. The device (1) comprises means (6) for deflecting, in a dissymmetric way, flaps (4A, 4B) of the airplane so as to laterally balance said airplane.

### CROSS-REFERENCE TO RELATED APPLICATIONS

This application claims priority to French Patent Application 0903059, filed Jun. 24, 2009, the contents of which are incorporated herein by reference.

### FIELD OF THE INVENTION

The present invention relates to a process and a device for laterally balancing in flight an airplane, in particular a transport airplane. By a lateral dissymmetry, it means a symmetry defect between the right side and the left side of the airplane, with respect of the median vertical plan of said airplane.

### BACKGROUND OF THE INVENTION

It is known that an airplane can be submitted, during a flight, to different types of lateral dissymmetries, i.e., more particularly:
temporary lateral dissymmetries being related to an abnormal operation of the airplane, for instance, a difference of fuel mass between the tanks of the right and left airfoils or a breakdown of an airfoil control surface; and
permanent dissymmetries being related to characteristics of the airplane, more specifically:
   either centring dissymmetries (through design: heavier elements on one side or elements being arranged on one single side of the airplane or through production scattering); or
   geometrical dissymmetries (airfoil twist, drift adjustment, fuselage torsion) either deliberated or through production scattering (while remaining within the production tolerances).

It is known that an airplane is generally provided with ailerons and with spoilers allowing for a rolling moment to be created:
for turning the airplane; and optionally
for compensating for the above mentioned lateral dissymmetries.

The aileron deflection (and optionally of the spoilers) in order to compensate for lateral dissymmetries could sometimes reach high values more specifically resulting in:
a loss of authority in a rolling condition; and
an increase of the drag and of the fuel consumption.

A lateral imbalance such as above described is generally compensated for as follows:
taking into account lateral dissymmetries related to breakdowns in the sizing of the rolling controls (ailerons and spoilers);
tolerance on the dissymmetry in flight;
compensation for permanent dissymmetries in the production phase of the airplane:
   an identification of the dissymmetry through geometrical measurements and/or with in-flight trials; and
   permanent compensation of the dissymmetry by mechanical means being external to the flight control systems, for instance, providing a divergent trailing edge.

Such usual methods for reducing or cancelling a lateral imbalance of an airplane have more specifically the following drawbacks:
a drop of performance being related to some cases of breakdowns, resulting from the high deflection of the rolling control surfaces (ailerons and spoilers);
drawbacks in design and in production for compensating for permanent dissymmetries:
   a need to identify the dissymmetry (with impacts on the costs and the production cycles); and
   an application of a physical modification on the airplane, and/or a need to provide, upon designing, compensation devices and the arrangement thereof (with impacts on the mass and the costs);
such a permanent dissymmetry compensation is unique for a given airplane.

Moreover, it is not definitely relevant for the whole operation field of the airplane; and
a lack of follow-up in time. The compensation as applied upon delivering the airplane is not necessarily relevant for the whole life period of the airplane, for example after modifications have been carried out on the airplane.

Consequently, the above mentioned usual methods intended for compensating for a lateral imbalance of an airplane (resulting from a lateral dissymmetry) are not completely satisfactory.

### SUMMARY OF THE INVENTION

The present invention relates to a process for laterally balancing in flight an airplane, enabling to overcome the above mentioned drawbacks.

To this end, according to this invention, said method for laterally balancing in flight an airplane, said airplane comprising trailing edge flaps being arranged symmetrically at the level of the trailing edges of both wings of the airplane and being able to be deflected symmetrically so as to modify the lift of the airplane, is remarkable in that, upon the airplane flying:
a) said airplane is automatically monitored so as to be able to detect a long term lateral dissymmetry; and
b) when a long term lateral dissymmetry is detected, automatically the trailing edge flaps are deflected dissymmetrically with respect to the median vertical plan of said airplane in order to compensate for said long term lateral dissymmetry so as to laterally balance said airplane.

Of course, the deflection of the trailing edge flaps is limited to predetermined maximal deflection values.

Thus, by means of this invention, a lateral dissymmetry of an airplane is compensated for in flight by dissymmetrically deflecting the trailing edge flaps, so as to create a rolling stress intended to compensate for the rolling being generated by the lateral dissymmetry.

For balancing the airplane, a dissymmetric deflection is performed of the trailing edge flaps, being contrary to their usual use. Such trailing edge flaps are, indeed, used for obtaining an increase of the lift at a low velocity and are symmetrically controlled with respect to the median vertical plan of the airplane.

According to this invention, the dissymmetric deflection relating to two flaps (symmetrically arranged), each of which being arranged on one of the wings of the airplane, is performed either by deflecting both flaps (one being deflected upwards and the other downwards), or by deflecting one of those two flaps (upwards or downwards), the other flap being not deflected.

The present invention allows for any type of long term lateral dissymmetry to be compensated for, as well as temporary dissymmetries as permanent dissymmetries. Within the present invention, a <<long term lateral dissymmetry>> is a lateral dissymmetry (either temporary or permanent) lasting at least for some time, allowing to state that such a dissymmetry is established and does not result from a transitory phenomenon. Such a time could be defined in terms of time, for example fifteen minutes, or in terms of flight phase. In this latter case, a dissymmetry could be considered being in the long term if it is expected to last at least during a whole flight phase (approach phase, take-off phase, . . . ).

When the ailerons (and optionally, the spoilers) of the airplane have the function of automatically compensating for lateral dissymmetries, implementing the balancing method according to this invention, using trailing edge flaps, avoids said ailerons (and optionally said spoilers) to have to perform such a compensation, so that they do not undergo any loss of authority in rolling (for roll steering the airplane).

In a first simplified embodiment, for laterally balancing in flight an airplane comprising ailerons intended for controlling the rolling axis thereof, said ailerons being controlled using a first deflecting order (usually determined) being variable depending on time, the following operations are performed in step b):
an average order is determined corresponding to the average of said first deflection order during a predetermined time, being preferably higher than ten minutes;
by means of at least one predetermined matching table, a second deflection order is determined, being intended for deflecting said trailing edge flaps and being applied to the latter such that it generates the same rolling value to the airplane as would be generated by deflecting said ailerons according to said average order; and
there is applied:
   to said trailing edge flaps, said second deflection order; and
   to said ailerons, in an iterative way, an auxiliary deflection order corresponding, at each iteration, to the difference between a first current deflection order and said average order.

Thus, in such a simplified embodiment, for which the ailerons are (usually) formed so as to perform (as an auxiliary function) an automatic compensation for a lateral dissymmetry, the compensation function of such a lateral dissymmetry is transferred to the trailing edge flaps so that the ailerons can then use their full authority for implementing their main roll steering function.

In addition, in a second embodiment, in step b), in an automatic and iterative way:
the current values of the flight parameters of the airplane are determined;
said current values and at least one matching table, a current deflection order is calculated, being intended for deflecting said trailing edge flaps in order to laterally balance the airplane; and
said current deflection order is applied to said trailing edge flaps.

Through this second embodiment, the compensation is modified if necessary permanently, depending on the current situation of the airplane, emphasized by the current values of said flight parameters (for example the velocity, the altitude, the mass, the incidence, etc.) of the airplane.

Furthermore, in a particular embodiment, advantageously:
the airplane is monitored so as to be able to detect a breakdown able to generate a lateral dissymmetry; and
when such a breakdown is detected, an additional deflection order is determined, allowing to compensate for such a lateral dissymmetry and such an additional deflection order is also applied to said trailing edge flaps.

Furthermore, advantageously, the deflection order is recorded, that has been applied to the trailing edge flaps. Recording such a deflection order:
could be implemented upon the first flight of the airplane and could be used for a mechanical control allowing to definitely compensating (mechanically) for the detected lateral dissymmetry (and compensated for by such a deflection order upon said first flight); or
could be implemented, upon any flight of the airplane, and be used upon the following flight as the deflection order of the trailing edge flaps.

Furthermore, advantageously, the lateral balancing function of the airplane is inhibited, when the pilot acts on a rolling control member of said airplane.

The present invention also relates to a device for laterally balancing in flight an airplane.

According to this invention, said device is remarkable in that it comprises:
trailing edge flaps being symmetrically arranged at the level of the trailing edges of both wings of the airplane;
monitoring means for automatically monitoring in flight said airplane so as to be able to detect a long term lateral dissymmetry of said airplane; and
means for automatically performing deflection of said trailing edge flaps, and this, in a dissymmetric way, with respect to the median vertical plan of said airplane, in order to compensate for said long term lateral dissymmetry so as to perform a lateral balancing of said airplane, when a long term lateral dissymmetry is detected by said monitoring means.

The present invention further relates to an airplane, in particular a transport airplane, comprising an in flight laterally balancing device, such as previously described.

### BRIEF DESCRIPTION OF THE DRAWINGS

The figures of the appended drawing will better explain how this invention can be implemented. In these figures like reference numerals relate to like components.

FIG. 1 is the block diagram of a device according to this invention, intended for laterally balancing in flight an airplane.

FIG. 2 is a planar view of an airplane, to which is applied a device according to this invention.

FIG. 3 is the block diagram of a particular embodiment of means being integrally part of a device according to this invention.

FIG. 4 is a plot allowing the characteristics of the embodiment of FIG. 3 to be emphasized.

FIG. 5 is the block diagram of a particular embodiment of means being integrally part of a device according to this invention.

### DETAILED DESCRIPTION

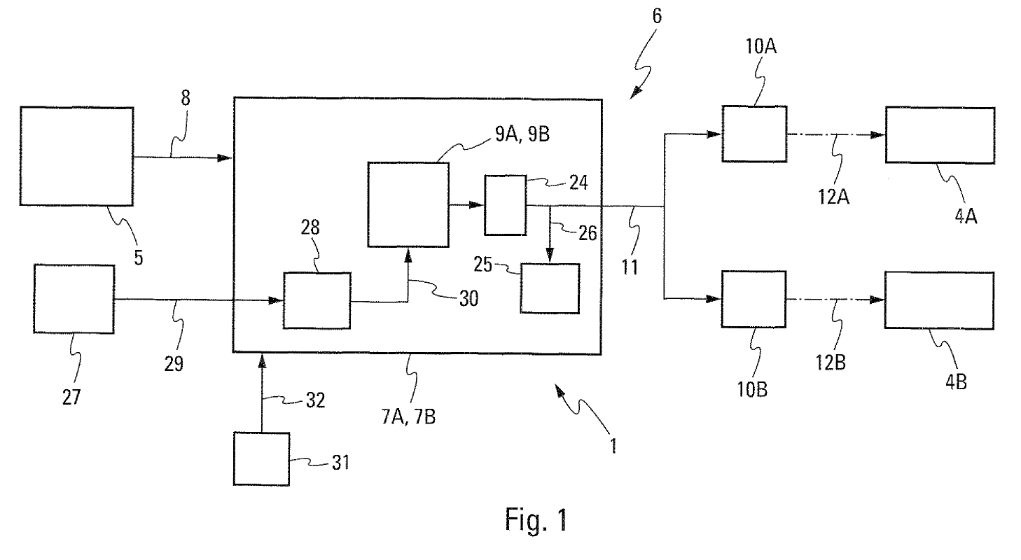

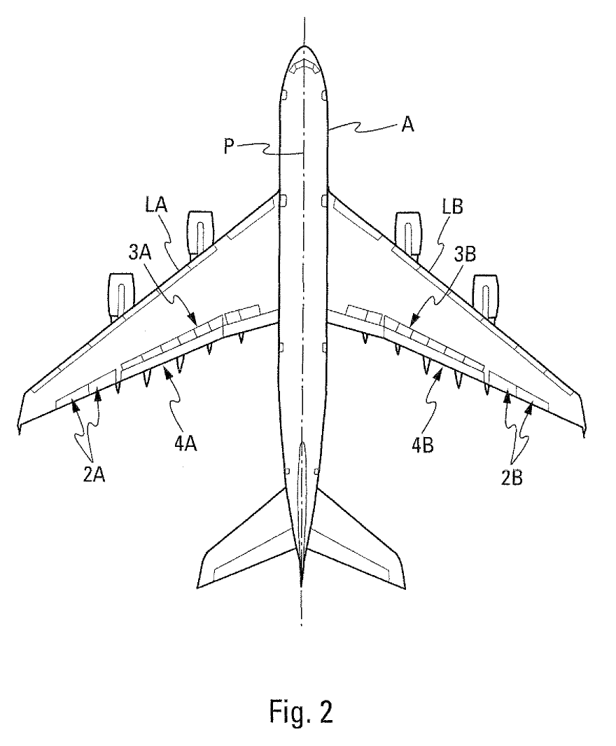

The device 1 according to this invention and schematically represented on FIG. 1 is intended for laterally balancing in flight an airplane A, in particular a transport airplane, such as shown as an example on FIG. 2.

Such an airplane A, in the present case a four-engine airplane, is provided with two wings LA, LB, each of which is provided:
with ailerons 2A, 2B and with spoilers 3A, 3B representing usual roll control surfaces; and
with trailing edge flaps 4A, 4B, being arranged in a symmetric way at the level of the trailing edges of the two wings LA, LB and being able to be usually deflected in a symmetric way for modifying the lift of the airplane A.

According to this invention, in order to perform a lateral balancing of said airplane A, the device 1 comprises:
usual monitoring means 5 for automatically monitoring in flight said airplane A so as to be able to detect a long term lateral dissymmetry of said airplane A. Within the context of the present invention, a lateral dissymmetry corresponds to a symmetry defect between the right side and the left side of the airplane A, with respect to the median vertical plan P of said airplane A (being represented by a dot-and-dash line on the plan view of FIG. 2); and
means 6 being intended to automatically performing a deflection of said flaps 4A and 4B of the trailing edge, and this in a dissymmetric way with respect to said median vertical plan P, in order to compensate for said lateral dissymmetry so as to perform a lateral balancing of said airplane A. The means 6 perform such a deflection when a long term lateral dissymmetry is detected by said monitoring means 5.

To do so, said means 6 comprise:
a unit 7A, 7B being connected via a link 8 to said monitoring means 5 and comprising means 9A, 9B for determining deflection orders of the flaps 4A and 4B of the trailing edge of the airplane A, allowing to compensate for a detected lateral dissymmetry; and
usual operating means 10A and 10B being connected via a link 11 to said unit 7A, 7B and being formed so as to (usually) control respectively said flaps 4A and 4B, as illustrated via links 12A and 12B in dot-and-dash line on FIG. 1, and this in accordance to the deflection orders as received from said unit 7A, 7B.

Thus, through this invention, a lateral dissymmetry of the airplane A is corrected in flight by dissymmetrically deflecting the trailing edge flaps 4A and 4B, being intended for creating a rolling effect allowing to compensate for the rolling generated by the lateral dissymmetry.

Such a dissymmetric deflection as generated by the device 1 is contrary to the usual use of the trailing edge flaps 4A and 4B. Such trailing edge flaps 4A and 4B are, indeed, provided on the airplane A for generating an increase of the lift at a low velocity and are, to this end, controlled in a symmetric way with respect to the median vertical plan P of the airplane A.

According to this invention, dissymmetrically deflecting the two flaps 4A and 4B, each of which is arranged on one of the wings LA and LB of the airplane A, is performed, either by simultaneously deflecting the two flaps (one being deflected upwards and the other downwards), or by deflecting one single flap amongst these two flaps (upwards or downwards). The choice between these two deflection possibilities could be performed as a function of the mechanical capacities of the means being used and/or of the optimization needs (for example minimizing the drag).

The device 1 according to the present invention thus allows for compensating any type of long term lateral dissymmetry, temporary dissymmetries (resulting from breakdowns) as well as permanent dissymmetries (production dissymmetry). Within the present invention, there is meant by a <<long term lateral dissymmetry>> a lateral dissymmetry (either temporary or permanent) lasting at least for some time, allowing to state that such a dissymmetry is established and does not result from a transitory phenomenon. Such a time could be defined in terms of time, for example fifteen minutes, or in terms of flight phase. In this latter case, a dissymmetry could be considered being in the long term if it is expected to last at least during a whole flight phase (approach phase, take-off phase, . . . ).

When the function of the ailerons 2A, 2B (and optionally the spoilers 3A, 3B of the airplane A) comprises compensating for dissymmetries, implementing the balancing method according to this invention using trailing edge flaps 4A, 4B, avoids said ailerons 2A, 2B (and optionally the spoilers 3A, 3B) to have to perform such a compensation, so that they do not undergo any loss of authority in rolling (for roll steering the airplane A).

A first (simplified) embodiment of this invention is intended for an in-sight lateral balancing of an airplane A comprises ailerons 2A and 2B provided for automatically controlling the rolling axis thereof, being controlled by a deflection order δa. In such a case, usually, said ailerons 2A and 2B are controlled by means of a deflection order δa presenting a value δa1 being variable as a function of the time t and being usually determined.

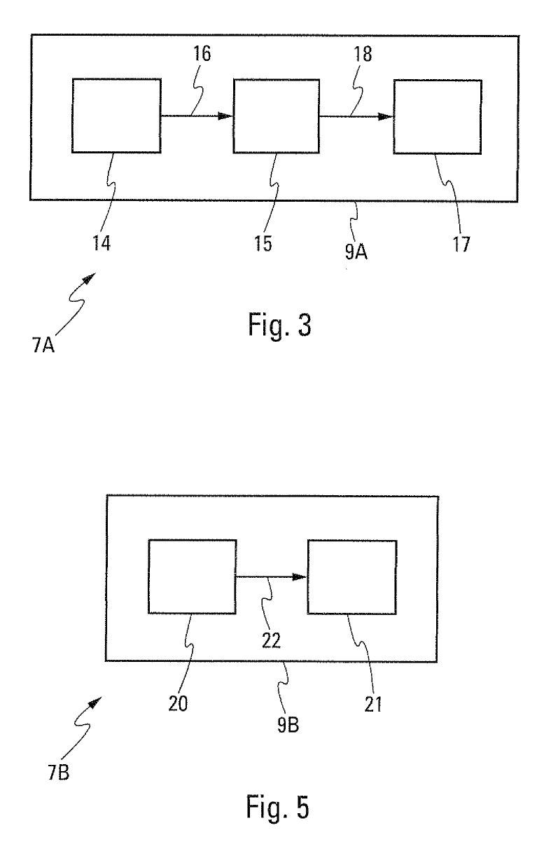

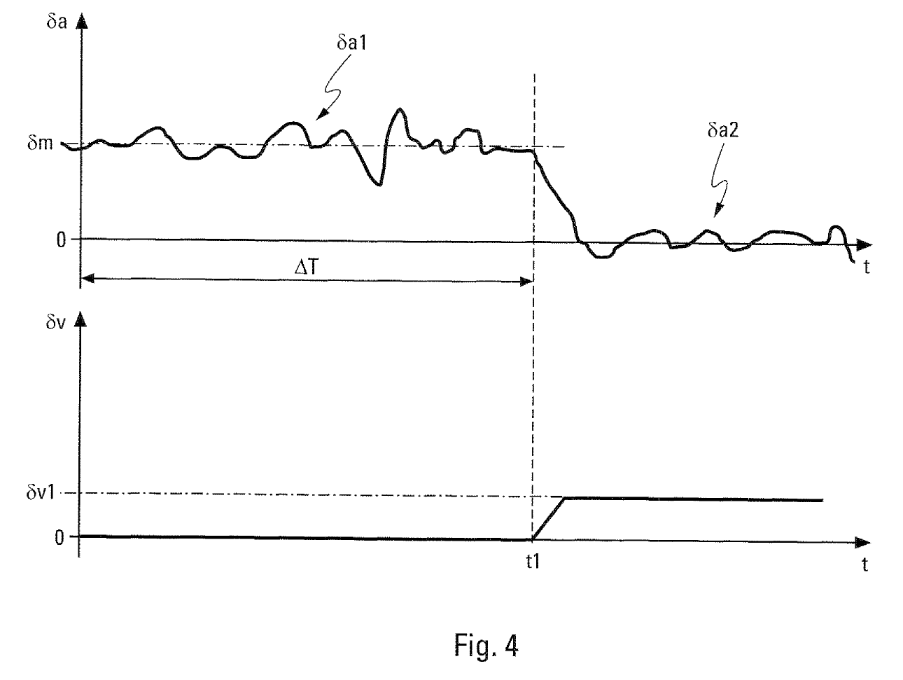

In such a first embodiment, said unit 7A comprises, as shown on FIG. 3, means 9A comprising:
means 14 for supplying the usual deflection order Sal for the ailerons 2A and 2B;
means 15 being connected via a link 16 to said means 14 and being formed so as to determine an average order δm corresponding to the average of said deflection order δa1 for a predetermined time ΔT, for example for fifteen minutes, as represented on FIG. 4; and
means 17 being connected via a link 18 to said means 15 and being formed so as to determine, by means of at least a predetermined matching table, a deflection order δv1 being intended for deflecting said trailing edge flaps 4A and 4B.

According to this invention, such a deflection order δv1 is such that, when applied to said trailing edge flaps 4A and 4B, it generates the same rolling value to the airplane A as would be generated deflecting said ailerons 2A and 2B according to said average order δm.

The above mentioned matching table could be empirically determined, including through in-flight trials.

Such a deflection order δv1 is then applied from a time t1, as previously indicated, to said trailing edge flaps 4A and 4B.

In this case, the device I further comprises (not shown) means for calculating an auxiliary deflection order δa2 corresponding to the difference between the current deflection order δa1 (supplied by means 14) and said average order δm (determined by means 15), as well as (not shown) usual means for applying (from time t1) such an auxiliary deflection order δa2 to the ailerons 2A and 2B of the airplane A. The average value of such an order δa2 is null.

Thus, in this simplified embodiment, wherein the ailerons 2A and 2B are formed so as to perform an automatic compensation for a lateral dissymmetry, the device 1 transfers the compensation function for such a lateral dissymmetry to the trailing edge flaps 4A and 4B so that the ailerons 2A and 2B (and optionally the spoilers 3A and 3B) can use their full authority for implementing their main roll steering function.

Furthermore, in a second embodiment, said unit 7B comprises, as shown on FIG. 5, means 9B comprising:
means 20 for usually determining, the current values of the flight parameters (for example the velocity, the altitude, the mass, the incidence, etc.) of the airplane A; and
means 21 being linked via a link 22 to said means 20 and being formed so as to calculate by means of said current values and at least a matching table, a current deflection order being intended to deflect said trailing edge flaps 4A and 4B in order to laterally balance the airplane A. Said matching table could be empirically determined, including using in-flight trials.

Using this second embodiment, the compensation is modified permanently if necessary, and this as a function of the current situation of the airplane A, being emphasized by the current values of said flight parameters.

In the two previous embodiments, the monitoring as implemented by means 5 could be a specific monitoring. This could also be an intrinsic monitoring, triggering the lateral balancing as soon as the average value δm is not null or is higher than a predetermined value or as soon as the current values of the flight parameters are representative of a lateral dissymmetry.

Furthermore, said unit 7A, 7B further comprises:
means 24 (provided at the outlet of means 9A, 9B) for limiting the deflection of the trailing edge flaps 4A and 4B to predetermined maximum deflection values; and
means 25 (being connected via a link 26 to the link 11) for recording the deflection order δv1 being applied to the trailing edge flaps 4A and 4B.

Recording such a defection order δv1:
could be performed upon the first flight of the airplane A and could be used for performing a mechanical control, at the level of the airfoil, more specifically, allowing to definitely compensate mechanically for the detected lateral dissymmetry (and compensated for by such a deflection order δv1 upon said first flight); or
could be implemented, during any flight of the airplane A and could be used during the following flight as the initial defection order of the trailing edge flaps 4A and 4B.

Furthermore, in a particular embodiment, the device 1 further comprises:
means 27 for monitoring the airplane A so as to be able to detect a particular breakdown able to generate a lateral dissymmetry; and
means 28 being linked via links 29 and 30 to said means 27 and 9A, 9B and being formed so as to determine, upon such a detection, an additional deflection order allowing to compensate for such a lateral dissymmetry (generated by the breakdown).

The device 1 further applies such an additional deflection order to said trailing edge flaps 4A, 4B.

Moreover, in a particular embodiment, the device 1 further comprises means 31 (being for example linked via a link 32 to the unit 7A, 7B), intended to inhibit the lateral balance function of the airplane A, when the pilot acts on a usual member (not shown) for controlling the rolling of said airplane A.

1. A process for laterally balancing in flight an airplane (A), said airplane (A) comprising trailing edge flaps (4A, 4B) being arranged in a symmetric way at the level of the trailing edges of the two wings (LA, LB) of the airplane (A) and being able to be deflected symmetrically for modifying the lift of the airplane (A) during flight, comprising:
a) automatically monitoring said airplane (A) so as to be able to detect a long term lateral dissymmetry, a long term lateral dissymmetry being a lateral dissymmetry lasting for a time allowing to state it does not result from a transitory phenomenon; and
b) when a long term lateral dissymmetry is detected, automatically the trailing edge flaps (4A, 4B) are deflected dissymmetrically with respect to the median vertical plan (P) of said airplane (A) in order to compensate for said long term lateral dissymmetry so as to laterally balance said airplane (A).

2. A process according to claim 1, for laterally balancing in flight an airplane (A) comprising ailerons (2A, 2B) intended to control the rolling axis thereof, said ailerons (2A, 2B) being controlled using a first deflection order (δa1) being variable as a function of time (t), wherein step b) comprises:
determining an average order (δm) corresponding to the average of said first deflection order (δa1) for a predetermined duration (ΔT);
using at least one predetermined matching table, a second deflection order (δv1) is determined being intended for deflecting said trailing edge flaps (4A, 4B) and being, when applied to the latter, such that it generates the same rolling value to the airplane (A) as deflection of said ailerons (2A, 2B) would generate according to said average order (δm); and
applying:
said trailing edge flaps (4A, 4B), said second deflection order (δv1); and
to said ailerons (2A, 2B), in an iterative way, an auxiliary deflection order (δa2) corresponding, at each iteration, to the difference between a first current deflection order (δa1) and said average order (δm).

3. A process according to claim 2, wherein said predetermined time (ΔT) is higher than ten minutes.

4. A process according to claim 1, wherein step b) comprises:
automatically and iteratively:
determining the current values of the flight parameters of the airplane (A);
using said current values and at least one matching table, a current deflection order is calculated, being intended for deflecting said trailing edge flaps(4A, 4B) in order to laterally balance the airplane (A); and
applying said current deflection order to said trailing edge flaps (4A, 4B).

5. A process according to claim 1, comprising:
monitoring the airplane (A) so as to be able to detect a breakdown able to generate a lateral dissymmetry; and
determining, when such a breakdown is detected, an additional deflecting order, allowing to compensate for such a lateral dissymmetry and such an additional deflection order is also applied to said trailing edge flaps (4A, 4B).

6. A process according to claim 1, comprising:
recording the deflection order (δv1) that has been applied to the trailing edge flaps (4A, 4B).

7. A process according to claim 1, comprising:
inhibiting the lateral balancing function of the airplane (A), when the pilot acts on a rolling control member of said airplane (A).

8. A process according to claim 1, comprising:
limiting the deflection of the trailing edge flaps (4A, 4B) to predetermined maximum deflection values.

9. A device for laterally balancing in flight an airplane (A), comprising:
trailing edge flaps (4A, 4B) of wings, being arranged in a symmetric way at the level of the trailing edges of the two wings (LA, LB) of the airplane (A);
monitoring means (5) for automatically monitoring in flight said airplane (A) so as to be able to detect a long term lateral dissymmetry of said airplane (A), a long term lateral dissymmetry being a lateral dissymmetry lasting for a time allowing to state
that is does not result from a transitory phenomenon; and
means (6) for automatically performing deflecting said trailing edge flaps (4A, 4B) and this in a dissymmetric way with respect to the median vertical plan (P) of said airplane (A), in order to compensate for said long term lateral dissymmetry so as to perform a lateral balancing of said airplane (A), when a long term lateral dissymmetry is detected by said monitoring means (5).

10. An airplane, comprising a laterally balancing device (1) according to claim 9.
